(19) United States
(12) Patent Application Publication
(10) Pub. No.: US 2013/0263998 A1
(43) Pub. Date: Oct. 10, 2013

(54) ULTRASONIC WELDING STRUCTURE AND ULTRASONIC WELDING METHOD

(71) Applicants: PO-SHENG WANG, New Taipei City (TW); CHUN-HSIANG HSU, New Taipei City (TW); CHING-FENG HSIEH, Taipei City (TW)

(72) Inventors: PO-SHENG WANG, New Taipei City (TW); CHUN-HSIANG HSU, New Taipei City (TW); CHING-FENG HSIEH, Taipei City (TW)

(73) Assignees: ASKEY COMPUTER CORP.; ASKEY TECHNOLOGY (JIANGSU) LTD.

(21) Appl. No.: 13/494,161

(22) Filed: Jun. 12, 2012

(30) Foreign Application Priority Data
Apr. 6, 2012 (TW) 101112248

(51) Int. Cl. B29C 65/08; B32B 37/06; B23K 20/10

(52) U.S. Cl. 156/73.1; 156/580.1; 228/1.1; 228/110.1

(57) ABSTRACT

An ultrasonic welding structure includes a welding plane and an energy-directing edge. The welding plane is formed on a first object or a second object. The energy-directing edge is formed on the first object or the second object and corresponds in position to the welding plane. The welding plane is oblique to a lamination direction of an ultrasonic device. The first object and the second object are welded together by ultrasonic welding which requires laminating the first object to the second object in the lamination direction so as for the energy-directing edge to exert a contact pressure upon the welding plane. Due to the welding plane and the energy-directing edge, ultrasonic welding thus performed requires less welding area and alignment structure than are taught by the prior art and is conducive to miniaturization of mobile electronic products.

### CROSS-REFERENCE TO RELATED APPLICATION

This non-provisional application claims priority under 35 U.S.C. §119(a) on Patent Application No(s). 101112248 filed in Taiwan, R.O.C. on Apr. 6, 2012, the entire contents of which are hereby incorporated by reference.

### FIELD OF TECHNOLOGY

The present invention relates to welding structures and methods, and more particularly, to an ultrasonic welding structure and method for use with an ultrasonic device.

### BACKGROUND

Ultrasonic welding technology is about joining two materials by melting them with heat generated from ultrasonic oscillation and then laminating them together, such that the molten materials flow and fill the gap between the two unaffected portions of the two materials, respectively. Upon cooling and shaping, the two materials are joined together.

Referring to FIG. 1, there is shown a schematic view of a conventional ultrasonic welding structure. To be welded together, a first element 110 and a second element 120 must have their respective welding structures which correspond in position to each other. For example, the welding structures of the first and second elements 110, 120 are an energy-directing ridge 111 and a welding plane 121, respectively. The energy-directing ridge 111 is disposed on the welding plane-facing side of the first element 110, and has a triangular cross-section. The vertex of the triangular cross-section of the energy-directing ridge 111 points at the welding plane 121 and thereby reduce the area of contact between the first and second elements 110, 120. Hence, ultrasonic energy and heat thus generated are focused at the vertex of the triangular cross-section of the energy-directing ridge 111, and in consequence the melting of the first element 110 and the second element 120 begins at the vertex of the triangular cross-section of the energy-directing ridge 111. Afterward, the lamination step starts from the vertex as well.

The lamination step involves applying a force to the elements evenly with a welding head so as to laminate the first element 110 and the second element 120 to each other after alignment of the first element 110 and the second element 120 is finished and thereby ensure that the first element 110 and the second element 120 can be precisely aligned with each other. Hence, the welding quality depends on the alignment structures of the first and second elements 110, 120. Furthermore, ultrasonic welding technology is characterized in that: an ultrasonic source causes the elements to vibrate, be confronted with friction, and eventually generate heat, and eventually causes the molten materials to flow and fill the gap between the first element 110 and the second element 120. Hence, it is necessary for a gap to exist between the first element 110 and the second element 120 so as to provide the room required for the filling of material and vibration.

Referring to FIG. 2A and FIG. 2B, a melting enhancing ridge 111 corresponding in position to the welding plane 121 is disposed on the first element 110. The melting enhancing ridge 111 is disposed on the welding plane-facing side of the first element 110, and has a triangular cross-section. The vertex of the triangular cross-section of the melting enhancing ridge 111 points at the welding plane 121 and thereby reduce the area of contact between the first and second elements 110, 120. Hence, ultrasonic energy and heat thus generated are focused at the vertex of the triangular cross-section of the melting enhancing ridge 111, and in consequence the melting of the first element 110 and the second element 120 begins at the vertex of the triangular cross-section of the melting enhancing ridge 111. Afterward, the lamination step starts from the vertex as well. Upon cooling and shaping, the two materials are joined together.

FIG. 2A and FIG. 2B are schematic views of ultrasonic welding structures for use in step joint welding and groove joint welding, respectively. The first element 110 is positioned at and welded to the second element 120. Referring to FIG. 2A, the second element 120 has a step-like structure. The step-like structure has the welding plane 121 and an alignment plane 122 which are substantially perpendicular to each other. During the lamination process, the first element 110 is laminated to the second element 120 by moving along the alignment plane 122. It is necessary that a gap is formed between the first element 110 and the alignment plane 122 of the second element 120, as the gap provides the room required for vibration. Referring to FIG. 2B, alternatively, the second element 120 has a groove-like structure. The bottom side of the groove-like structure functions as the welding plane 121. The two lateral sides of the groove-like structure function as alignment planes 122a, 122b corresponding in position to the first element 110. During the lamination process, the first element 110 is laminated to the second element 120 by moving along the alignment planes 122a, 122b. During the lamination process, the molten material fills the minute gap between the welding plane 121 and the melting enhancing ridge 111.

In addition, the alignment planes 122a, 122b serve to prevent the molten material from overflowing the groove-like structure. It is necessary that a gap is formed between the first element 110 and the alignment planes 122a, 122b of the second element 120, as the gap provides the room required for vibration. Electronic consumer products nowadays have a trend toward downsizing the commercially available mobile electronic products. For instance, mobile electronic products, such as smartphones, tablet computers, and notebook computers are becoming more compact and lightweight in order to meet the requirements of portability, ease of use, and high performance. Factors in miniaturization of mobile electronic products include internal element design and manufacturing. The aforesaid conventional ultrasonic welding structure features an energy-directing line and a welding plane which are formed at the two elements to be welded together. To provide the gap to be filled by the molten material, provide an alignment structure, and enable ultrasonic oscillation, the aforesaid conventional ultrasonic welding structure has to have the required thickness of the elements, an external structure of a positioning frame, and the specific structure shown in FIG. 2A and FIG. 2B; as a result, it is impossible for the aforesaid conventional ultrasonic welding structure to downsize its elements and thereby downsize the resultant mobile electronic products.

### SUMMARY

It is an objective of the present invention to provide an ultrasonic welding structure and ultrasonic welding method so as to reduce the space required for ultrasonic welding and thereby downsize mobile electronic products for the sake of miniaturization.

In order to achieve the above and other objectives, the present invention provides an ultrasonic welding structure which is applicable to an ultrasonic device and is intended to allow a first element to be laminated in a lamination direction to a second element and thereby welded and coupled thereto. The ultrasonic welding structure comprises a welding plane disposed on one of the first element and the second element and being oblique to the lamination direction; and an energy-directing edge disposed on another one of the first element and the second element, corresponding in position to the welding plane, and exerting a contact pressure upon the welding plane during the laminating the first element to the second element in the lamination direction so as to weld the first element and the second element together by ultrasonic welding.

As regards the ultrasonic welding structure, the second element has an engaging portion, and the engaging portion is a recess. The recess defines a receiving space corresponding in shape to the first element.

As regards the ultrasonic welding structure, the energy-directing edge is a step-like structure.

As regards the ultrasonic welding structure, the second element has an engaging portion, and the engaging portion is a recess. The energy-directing edge is formed at the edge of the first element. The energy-directing edge is right-angled.

In order to achieve the above and other objectives, the present invention further provides an ultrasonic welding method for use with an ultrasonic device. The ultrasonic welding method comprises the steps of: providing a first element and a second element, wherein one of the first element and the second element is formed with a welding plane and another one with an energy-directing edge corresponding in position to the welding plane; and laminating the first element to the second element in a lamination direction so as to weld the first element and the second element together, wherein the welding plane is oblique to the lamination direction so as for the energy-directing edge to exert a contact pressure upon the welding plane, thereby welding the first element and the second element together by ultrasonic oscillation of the ultrasonic device.

As regards the ultrasonic welding method, the second element has an engaging portion. The engaging portion is a recess. The recess defines a receiving space corresponding in shape to the first element.

As regards the ultrasonic welding method, the energy-directing edge is a step-like structure.

As regards the ultrasonic welding method, the second element has an engaging portion. The engaging portion is a recess. The energy-directing edge is formed at the edge of the first element and is right-angled.

Accordingly, the ultrasonic welding structure in the embodiments of the present invention is advantageously characterized by a welding plane oblique to a lamination direction for increasing the surface area available for welding so as to reduce the required thickness of the material used, maintain sufficient welding strength, and achieve a waterproofing feature. In addition, the ultrasonic welding structure in the embodiments of the present invention is further characterized in that alignment is jointly achieved by a welding plane, an energy-directing edge, and an engaging portion to thereby dispense with any alignment-enabling structure, such as a recess, a groove, or an alignment frame, and in consequence benefits are attained, including reduction of the required thickness of the material used, reduction of the required internal layout space, and reduction of the welding-required space and structure by at least 50% when compared with the prior art. In conclusion, the ultrasonic welding structure and method of the present invention are conducive to miniaturization of mobile electronic products and reduction of manufacturing costs.

### BRIEF DESCRIPTION OF THE DRAWINGS

Objectives, features, and advantages of the present invention are hereunder illustrated with specific embodiments in conjunction with the accompanying drawings, in which:

FIG. 1 (PRIOR ART) is a schematic view of a conventional ultrasonic welding structure;

FIG. 2A and FIG. 2B (PRIOR ART) are schematic views of conventional ultrasonic welding structures for use in step joint welding and groove joint welding, respectively;

FIG. 3A through FIG. 3C are schematic views of an ultrasonic welding structure according to the first embodiment of the present invention; and

FIG. 4A through FIG. 4C are schematic views of the ultrasonic welding structure according to the second embodiment of the present invention.

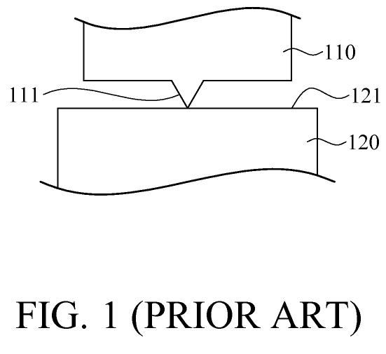

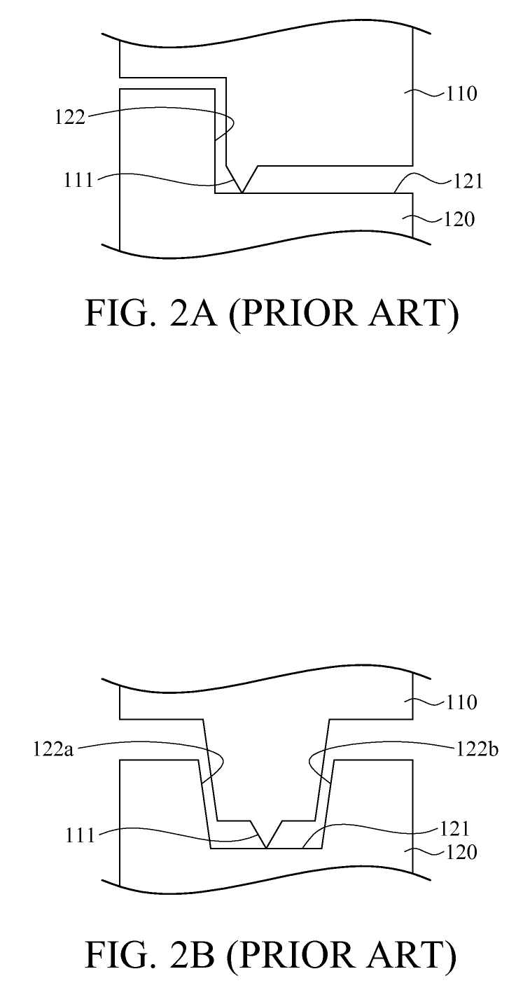

### DETAILED DESCRIPTION

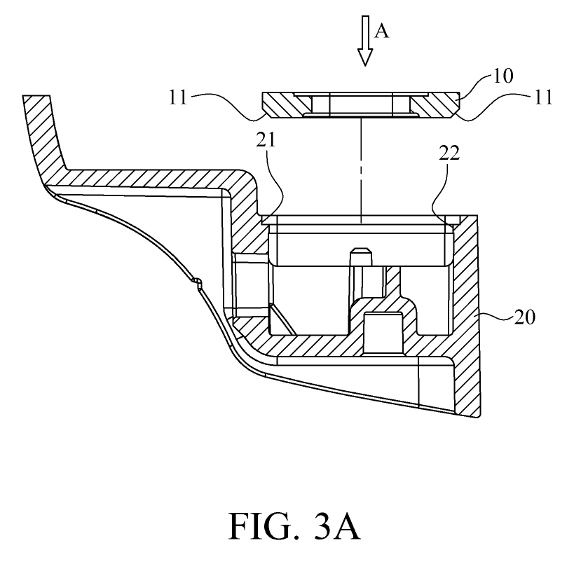

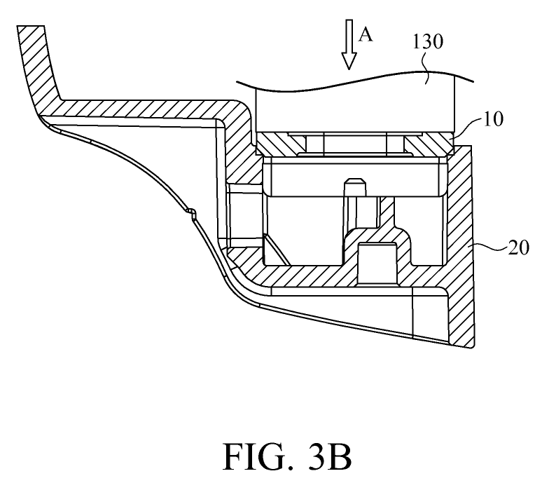

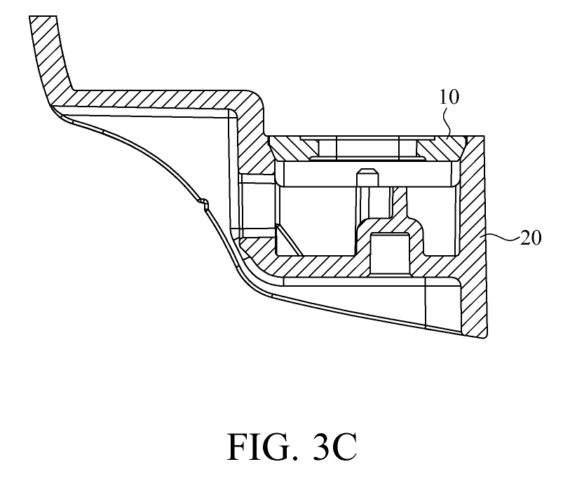

Referring to FIG. 3A through FIG. 3C, there are shown schematic views of an ultrasonic welding structure according to the first embodiment of the present invention. In the first embodiment of the present invention, the ultrasonic welding structure is applicable to an ultrasonic device and is adapted to allow a first element 10 to be laminated in a lamination direction A to a second element 20 so as to be welded and coupled thereto. The ultrasonic welding structure comprises a welding plane 11 disposed on the first element 10. The welding plane 11 is oblique to the lamination direction A. The ultrasonic welding structure further comprises an energy-directing edge 22 which corresponds in position to the welding plane 11 and is disposed on the second element 20. Due to the energy-directing edge 22, when the first element 10 is laminated in the lamination direction A to the second element 20, the energy-directing edge 22 exerts a contact pressure upon the welding plane 11, such that the first element 10 and the second element 20 are joined together by ultrasonic welding.

In this embodiment, the second element 20 has an engaging portion 21. The engaging portion 21 is a recess. As shown in the diagrams, the recess defines a receiving space corresponding in shape to the first element 10. The energy-directing edge 22 is a step-like structure formed at the engaging portion 21 of the second element 20. The energy-directing edge 22 concentrates and guides ultrasonic energy to generate friction-induced heat between the first element 10 and the second element 20 and thereby cause material melting. During the lamination process, the sharp edge of the energy-directing edge 22 applies pressure to the welding plane 11, and thus the molten material flows and fills the minute gap between the welding plane 11 of the first element 10 and the energy-directing edge 22 of the second element 20.

Referring to FIG. 3A, the process of ultrasonic welding performed on the first element 10 and the second element 20 starts with putting the first element 10 and the second element 20 in an ultrasonic device in a manner that the welding plane 11 of the first element 10 corresponds in position to the energy-directing edge 22 of the engaging portion 21 of the second element 20.

Referring to FIG. 3B, the first element 10 is laminated in the lamination direction A to the second element 20 by means of a welding head 130 of the ultrasonic device. Since the engaging portion 21 (that is, a recess) corresponds in shape to the first element 10, sidewalls of the engaging portion 21 enable the alignment of the first element 10 with the engaging portion 21 of the second element 20, and thus the first element 10 moves into the engaging portion 21 by sliding along the sidewalls thereof. During the lamination step, the energy-directing edge 22 exerts a contact pressure upon the welding plane 11, while heat is being generated because of the enhanced friction between the first element 10 and the second element 20 to facilitate the melting and resultant welding of the affected portions of the first element 10 and the second element 20. The friction between the first element 10 and the second element 20 is enhanced by ultrasonic oscillation.

Referring to FIG. 3C, there is shown a schematic view of the first element 10 and the second element 20 upon completion of the ultrasonic welding thereof. As shown in FIG. 3C, upon completion of the ultrasonic welding process, the top surface of the first element 10 is flush with the second element 20, because the first element 10 fits the receiving space of the engaging portion 21 and thus is well received therein. Alternatively, in a variant embodiment (not illustrated with the diagrams) of the present invention, upon completion of the ultrasonic welding process, the first element 10 is higher than the second element 20, because the receiving space of the engaging portion 21 is designed to accommodate the first element 10 in part rather than in whole.

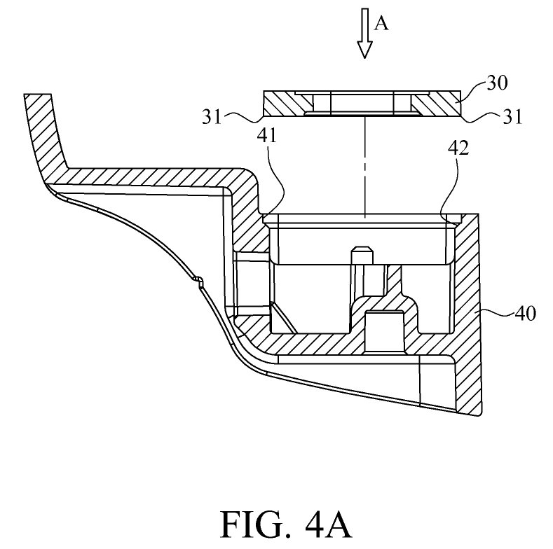

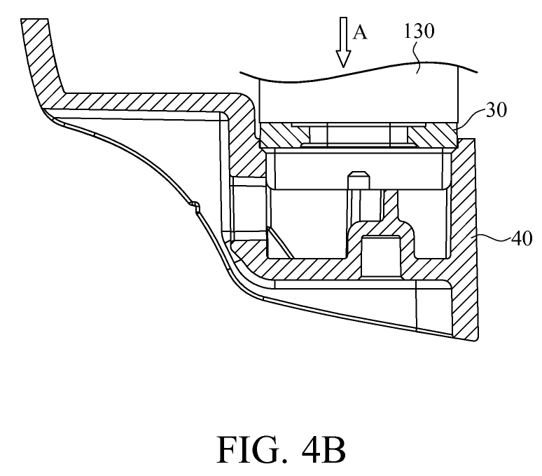

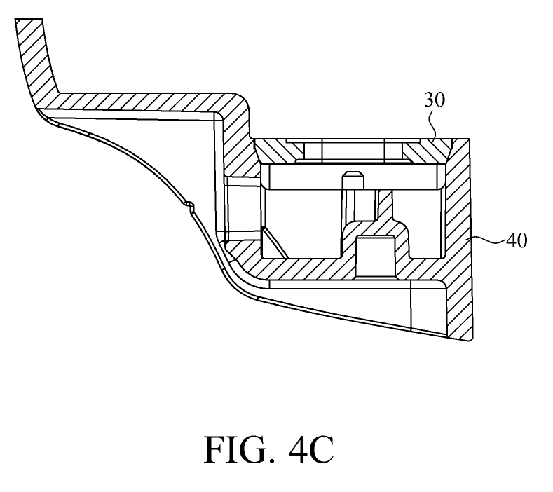

Referring to FIG. 4A through FIG. 4C, there are shown schematic views of the ultrasonic welding structure according to the second embodiment of the present invention. In the second embodiment of the present invention, the ultrasonic welding structure is adapted for welding a first element 30 to a second element 40. With the ultrasonic welding structure working in conjunction with the ultrasonic device, the first element 30 can be laminated in the lamination direction A to the second element 40 and thereby welded thereto. The ultrasonic welding structure comprises a welding plane 42 disposed on the second element 40. The welding plane 42 is oblique to the lamination direction A. The ultrasonic welding structure further comprises an energy-directing edge 31 corresponding in position to the welding plane 42 and disposed on the first element 30. When the first element 30 is laminated in the lamination direction A to the second element 40, the energy-directing edge 31 exerts a contact pressure on the welding plane 42, such that the first element 30 and the second element 40 are joined together by ultrasonic welding.

In this embodiment, the second element 40 has an engaging portion 41 as shown in FIG. 4A. The engaging portion 41 is a recess. The recess defines a receiving space corresponding in shape to the first element 30.

In this embodiment, the energy-directing edge 31 is disposed at the edge of the first element 30. That is to say, the intrinsic edge of the first element 30 functions as the energy-directing edge 31. The energy-directing edge 31 is right-angled and is adapted to concentrate and guide ultrasonic energy, such that heat is generated because of the enhanced friction between the first element 30 and the second element 40 to facilitate the melting and resultant welding of the affected portions of the first element 30 and the second element 40. The friction between the first element 10 and the second element 20 is enhanced by ultrasonic oscillation. During the lamination process, the right-angled edge of the energy-directing edge 31 applies pressure to the welding plane 42, and thus the molten material flows and fills the minute gap between the first element 30 and the second element 40.

Referring to FIG. 4A, the process of ultrasonic welding performed on the first element 30 and the second element 40 starts with putting the first element 30 and the second element 40 in the ultrasonic device in a manner that the energy-directing edge 31 of the first element 30 corresponds in position to the welding plane 42 of the engaging portion 41 of the second element 40.

Referring to FIG. 4B, the first element 30 is laminated in the lamination direction A to the second element 40 by means of the welding head 130 of the ultrasonic device. Since the engaging portion 41 (that is, a recess) corresponds in shape to the first element 30, sidewalls of the engaging portion 41 enable the alignment of the first element 30 with the engaging portion 41 of the second element 40, and thus the first element 30 moves into the engaging portion 41 by sliding along the sidewalls thereof. During the lamination step, the energy-directing edge 31 exerts a contact pressure upon the welding plane 42, while heat is being generated because of the enhanced friction between the first element 30 and the second element 40 to facilitate the melting and resultant welding of the affected portions of the first element 30 and the second element 40. The friction between the first element 30 and the second element 40 is enhanced by ultrasonic oscillation.

Referring to FIG. 4C, there is shown a schematic view of the first element 30 and the second element 40 upon completion of the ultrasonic welding thereof. As shown in FIG. 4C, upon completion of the ultrasonic welding process, the top surface of the first element 30 is flush with the second element 40, because the first element 30 fits the receiving space of the engaging portion 41 and thus is well received therein. Alternatively, in a variant embodiment (not illustrated with the diagrams) of the present invention, upon completion of the ultrasonic welding process, the first element 30 is higher than the second element 40, because the receiving space of the engaging portion 41 is designed to accommodate the first element 30 in part rather than in whole.

Referring to FIG. 3A through FIG. 3C, the present invention further provides an ultrasonic welding method for use with an ultrasonic device having the ultrasonic welding structure described in the first embodiment of the present invention. The ultrasonic welding method comprises the steps of: providing the first element 10 and the second element 20, wherein the first element 10 is formed with the welding plane 11, and the second element 20 has the energy-directing edge 22 corresponding in position to the welding plane 11; and laminating the first element 10 to the second element 20 so as to weld the first element 10 and the second element 20 together, wherein the first element 10 is laminated to the second element 20 in the lamination direction A, the welding plane 11 being oblique to the lamination direction A so as for the energy-directing edge 22 to exert a contact pressure upon the welding plane 11, thereby welding the first element 10 and the second element 20 together by ultrasonic oscillation of the ultrasonic device.

Referring to FIG. 4A through FIG. 4C, the present invention further provides an ultrasonic welding method for use with an ultrasonic device having the ultrasonic welding structure described in the second embodiment of the present invention. The ultrasonic welding method comprises the steps of: providing the first element 30 and the second element 40, wherein the second element 40 is formed with the welding plane 42, and the first element 30 has the energy-directing edge 31 corresponding in position to the welding plane 42; and laminating the first element 30 to the second element 40 so as to weld the first element 30 and the second element 40 together, wherein the first element 30 is laminated to the second element 40 in the lamination direction A, the welding plane 42 being oblique to the lamination direction A so as for the energy-directing edge 31 to exert a contact pressure upon the welding plane 42, thereby welding the first element 30 and the second element 40 together by ultrasonic oscillation of the ultrasonic device.

Accordingly, an ultrasonic welding structure in the embodiments of the present invention is advantageously characterized by a welding plane oblique to a lamination direction for increasing the surface area available for welding so as to reduce the required thickness of the material used, maintain sufficient welding strength, and achieve a waterproofing feature. In addition, the ultrasonic welding structure in the embodiments of the present invention is further characterized in that alignment is jointly achieved by a welding plane, an energy-directing edge, and an engaging portion to thereby dispense with any alignment-enabling structure, such as a recess, a groove, or an alignment frame, and in consequence benefits are attained, including reduction of the required thickness of the material used, reduction of the required internal layout space, and reduction of the welding-required space and structure by at least 50% when compared with the prior art. In conclusion, the ultrasonic welding structure and method of the present invention are conducive to miniaturization of mobile electronic products and reduction of manufacturing costs.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. An ultrasonic welding structure for use with an ultrasonic device and for laminating, welding, and coupling a first element to a second element in a lamination direction, the ultrasonic welding structure comprises:
a welding plane disposed on one of the first element and the second element and being oblique to the lamination direction; and
an energy-directing edge disposed on another one of the first element and the second element, corresponding in position to the welding plane, and exerting a contact pressure upon the welding plane during the laminating the first element to the second element in the lamination direction so as to weld the first element and the second element together by ultrasonic welding.

2. The ultrasonic welding structure of claim 1, wherein the second element has an engaging portion, and the engaging portion is a recess.

3. The ultrasonic welding structure of claim 1, wherein the energy-directing edge is a step-like structure.

4. The ultrasonic welding structure of claim 1, wherein the energy-directing edge is disposed at an edge of the first element.

5. The ultrasonic welding structure of claim 1, wherein the energy-directing edge is right-angled.

6. An ultrasonic welding method for use with an ultrasonic device, comprising the steps of:
providing a first element and a second element, wherein one of the first element and the second element is formed with a welding plane and another one with an energy-directing edge corresponding in position to the welding plane; and
laminating the first element to the second element in a lamination direction so as to weld the first element and the second element together, wherein the welding plane is oblique to the lamination direction so as for the energy-directing edge to exert a contact pressure upon the welding plane, thereby welding the first element and the second element together by ultrasonic oscillation of the ultrasonic device.

7. The ultrasonic welding method of claim 6, wherein the second element has an engaging portion, and the engaging portion is a recess.

8. The ultrasonic welding method of claim 6, wherein the energy-directing edge is a step-like structure.

9. The ultrasonic welding method of claim 7, wherein the energy-directing edge is formed at an edge of the first element.

10. The ultrasonic welding method of claim 9, wherein the energy-directing edge is right-angled.
